(19) United States
(12) Patent Application Publication
(10) Pub. No.: US 2026/0239521 A1
(43) Pub. Date: Aug. 13, 2026

(54) METHOD AND LASER APPARATUS FOR GENERATING ANEUV LIGHT-EMITTING PLASMA OF A TARGET MATERIAL

(71) Applicant: TRUMPF Lasersystems for Semiconductor Manufacturing SE, Ditzingen (DE)

(72) Inventors: Wolfgang Weber, Leonberg (DE); Charlotte Peschke, Stuttgart (DE)

(21) Appl. No.: 19/529,173

(22) Filed: Feb. 4, 2026

(30) Foreign Application Priority Data
Feb. 12, 2025 (DE) 102025105185.2

(51) Int. Cl. H05G 2/00

(52) U.S. Cl. CPC H05G 2/0084; H05G 2/002; H05G 2/0086

(57) ABSTRACT

A method for generating an extreme ultraviolet (EUV) light-emitting plasma of a target material includes generating at least one first main pulse and at least one second main pulse with a pulse-time difference therebetween, feeding the target material into a target chamber, and causing the at least one first main pulse and the at least one second main pulse be incident on the target material with an incidence-time difference therebetween. The pulse-time difference is greater than the incidence-time difference.

### CROSS REFERENCE TO RELATED APPLICATIONS

This application claims benefit to German Patent Application No. DE 10 2025 105 185.2, filed on Feb. 12, 2025, which is hereby incorporated by reference herein.

### FIELD

Embodiments of the present invention relate to a method, and to a laser apparatus, for generating an extreme ultraviolet (EUV) light-emitting plasma of a target material.

### BACKGROUND

The generation of an EUV light-emitting plasma of a target material is known from the prior art. Here, the target material in the form of droplets is provided by means of a droplet generator and irradiated by means of a laser beam pulse for the purpose of generating a plasma, with a laser beam pulse striking a droplet. When generating the plasma, the provision of the target material by means of the droplet generator constitutes a limiting factor. The droplet generator is capable of providing the droplets in a target chamber, with the attainable droplet frequency being far below an attainable pulse frequency, at which the laser beam pulses can be generated.

### SUMMARY

Embodiments of the present invention provide a method for generating an extreme ultraviolet (EUV) light-emitting plasma of a target material. The method includes generating at least one first main pulse and at least one second main pulse with a pulse-time difference therebetween, feeding the target material into a target chamber, and causing the at least one first main pulse and the at least one second main pulse be incident on the target material with an incidence-time difference therebetween. The pulse-time difference is greater than the incidence-time difference.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1, FIG. 2 and FIG. 3 show a laser apparatus in three different states according to some embodiments; and

FIG. 4 shows a temporal sequence of the generation of the main pulses and of the target material and of the incidence, according to some embodiments.

### DETAILED DESCRIPTION

Embodiments of the present invention can increase the conversion efficiency of generating an EUV light-emitting plasma of a target material.

According to some embodiments, a method for generating an EUV light-emitting plasma of a target material, comprising the following steps: generating at least one first laser beam main pulse and at least one second laser beam main pulse with a pulse-time difference, feeding the target material, in particular in the form of a droplet, into a target chamber, making the at least one first main pulse and the at least one second main pulse be incident on the target material with an incidence-time difference, wherein the pulse-time difference is designed to be greater than the incidence-time difference.

By virtue of the time difference for generating the main pulses being designed to be different from the time difference when the main pulses are incident on the target material, it is possible to use a higher pulse frequency of the beam source even at a lower target frequency. Accordingly, the pulse frequency may be increased for irradiating the target material, wherein the target frequency may remain unchanged. This increases the mean power of each pulse incident on the target material, whereby the EUV power obtained is also significantly increased as a result.

The first main pulse is generated at a first time. The second main pulse is generated at a second time. The pulse-time difference arises from the time difference between the first time and the second time.

The first main pulse is incident on the target material at a third time. The second main pulse is incident on the target material at a fourth time. The incidence-time difference arises from the time difference between the third time and the fourth time.

In the application, the terms laser beam, laser beam main pulse and main pulse are used synonymously.

Tin (Sb) material can be used as target material. However, in addition to the tin (Sb) material, target materials comprising xenon (Xe), gold (Au) and/or lithium (Li) are also possible.

An advantageous embodiment of the invention provides for a ratio between the incidence-time difference and the pulse-time difference to be designed to be less than 1:500, in particular less than 1:1000 and preferably approximately 1:1250. Accordingly, a particularly good utilization of a higher pulse frequency is ensured.

An advantageous embodiment of the invention provides for the incidence-time difference to be designed to be less than 1 μs, in particular less than 0.5 μs and preferably less than 0.1 μs. By preference, the first main pulse and the second main pulse are incident on the target material simultaneously. Accordingly, it is possible to ensure a particularly advantageous energy input into the target material. The pulse-time difference is preferably in a range between 2 μs and 10 μs, in particular between 4 μs and 8 μs.

An advantageous embodiment of the invention provides for a ratio between a pulse frequency, in particular a constant pulse frequency, of the main pulse generation and a target frequency, in particular constant target frequency, of the target material feed to be at least 2:1, in particular at least 4:1 and preferably at least 8:1. The pulse frequency may preferably be designed to be greater than the target frequency by a factor of 2\hat{ }n. Accordingly, the potential of a high pulse frequency of a laser source can be optimally utilized. By way of example, the pulse frequency can be 160 kHz, i.e. the pulse-time difference is 6.25 μs, and the target frequency can be 80 kHz, i.e. a target-time difference is 13 μs, with preferably the incidence-time difference being less than 1 μs, in particular less than 0.1 μs, preferably less than 0.01 μs and particularly preferably less than 1 ns.

Prior to incidence on the target material, the first main pulse covers a first propagation path, and the second main pulse covers a second propagation path. By preference, a retardation apparatus is provided for the purpose of synchronizing the first main pulse and the second main pulse. The first main pulse is delayed in the retardation apparatus such that the first propagation path of the first main pulse is designed to be greater than the second propagation path of the second main pulse. In this case, the retardation apparatus is designed such that the pulse-time difference is designed to be greater than the incidence-time difference and/or the incidence-time difference is designed to be less than 1 μs, in particular less than 0.5 μs, preferably less than 0.1 μs, preferably less than 0.01 μs and particularly preferably less than 1 ns and/or the first main pulse and the second main pulse are incident on the target material simultaneously. Accordingly, temporal synchronization of the main pulses generated with a time offset is realized with simple means. Consequently, the energy input into the target material can be increased significantly. Accordingly, plasma generation efficiency is improved.

In order to increase the amount of EUV light emitted, the droplets generated there by the droplet generator may e.g. initially be excited by a primary laser beam, which is known as the pre-pulse, and subsequently be excited by a secondary laser beam, which is known as the main pulse. The conversion efficiency increases significantly as a result of using a second excitation light beam. It is advantageous for a first main pulse to be generated first, followed by a pre-pulse and a second main pulse. The pre-pulse is initially incident on the droplet and shapes the latter. The two synchronized main pulses are subsequently incident on the shaped droplet. It is advantageous for the pre-pulse to be generated after the first main pulse but be incident on the droplet before the first main pulse.

The first main pulse is preferably introduced into the target chamber. In this case, the first main pulse and the target material are preferably matched to each other in time such that the main pulse is not incident on the target material. By preference, the first main pulse passes the intended region of incidence before the target material. The main pulse preferably passes the region of incidence temporally between two droplets of the target material provided. Accordingly, the first main pulse can be guided out of the target chamber again. The first main pulse is subsequently delayed, especially within a retardation apparatus. Delaying the first main pulse means that the first main pulse covers a propagation path. Subsequently, the first main pulse is reintroduced into the target chamber. In this case, the delay is designed such that the first main pulse and the second main pulse are introduced into the target chamber substantially simultaneously and are also incident on the target material substantially simultaneously. In this embodiment, the first main pulse is initially introduced into the target chamber and subsequently delayed. It is conceivable for the first main pulse to be delayed prior to being introduced into the target chamber in an alternative embodiment.

By preference, at least one polarization component of the first main pulse is modified before the latter is introduced into the target chamber. This change in polarization makes it possible to prevent unwanted retroreflections, which may cause irreparable damage to the beam source along a reversed beam path.

An advantageous embodiment of the invention provides for the first main pulse and/or the second main pulse to be guided into a beam trap when no target material is provided for the first main pulse and the second main pulse. Accordingly, reliable absorption of the delayed first main pulse and/or the second main pulse can be ensured, even in the event of a fault and at the end of operations.

By preference, a target material, in the form of a droplet, is generated first. The generation of the target material is accompanied by the generation of a target signal characterizing the time of target generation. The target signal triggers the generation of the first main pulse and, with a time offset given by the pulse-time difference, the generation of the second main pulse. Alternatively, it is conceivable that the generation of the first main pulse triggers the generation of the target material and, with a time offset given by the pulse-time difference, the generation of the second main pulse.

An advantageous embodiment of the invention comprises a method for generating an EUV light-emitting plasma of a target material, comprising the following steps: generating at least one first main pulse and at least one second main pulse, feeding the target material into a target chamber, making the at least one first main pulse and the at least one second main pulse be incident on the target material. The first main pulse covers a first propagation path prior to incidence on the target material. The second main pulse covers a second propagation path prior to incidence on the target material. The first main pulse is delayed, especially in a retardation apparatus, such that the main pulses are incident on the target material substantially simultaneously. In the process, the first main pulse preferably covers a longer propagation path than the second main pulse. Hence, the main pulses may jointly irradiate a droplet of target material despite the time interval between the generation of said main pulses.

Embodiments of the present invention also provide a laser apparatus for generating an EUV light-emitting plasma of a target material, the laser apparatus comprising: a pulsed beam source for generating at least one first main pulse and at least one second main pulse, an amplifier arrangement having at least one optical amplifier for amplifying the first main pulse and the second main pulse, a pump source for supplying the at least one optical amplifier with pump energy, a focusing apparatus for focusing the first main pulse and the second main pulse, a target material generator for providing the target material in a target chamber, a retardation apparatus for delaying the first main pulse, and a controller for controlling the beam source, the target material generator and the retardation apparatus, which is configured such that the first main pulse and the second main pulse are incident on the target material substantially simultaneously.

An advantageous embodiment of the invention provides for the controller to be configured such that the beam source generates the first main pulse and the second main pulse with a pulse-time difference and such that the first main pulse and the second main pulse are incident on the target material with an incidence-time difference. The pulse-time difference is preferably designed to be greater than the incidence-time difference.

An advantageous embodiment of the invention provides for the controller to be configured such that the incidence-time difference is designed to be less than 1 μs, in particular less than 0.5 μs, preferably less than 0.1 μs, preferably less than 0.01 μs and particularly preferably less than 1 ns. When the incidence-time difference substantially corresponds to 0, the first main pulse and the second main pulse are incident on the target material at least substantially simultaneously.

An advantageous embodiment of the invention provides for the laser apparatus to comprise a target mirror for guiding the first main pulse out of the target chamber in particular and into the retardation apparatus. The target mirror and/or the point of incidence are preferably located in the target chamber. Accordingly, a first main pulse which was introduced into the target chamber and which was not incident on a target material during the first passage through the target chamber can be introduced into the retardation apparatus and can be delayed there.

An advantageous embodiment of the invention provides for the retardation apparatus to comprise a laser trap for absorbing a main pulse. Accordingly, it is possible to capture main pulses which are not required for generating a plasma. For example, this may be the case if no target material is generated but a target signal nevertheless initiates the generation of a main pulse.

An advantageous embodiment of the invention provides for the target material generator to be designed as a droplet generator.

By preference, the first main pulse, in particular before and/or after the delay, and the second main pulse are focused onto the target material by means of the individual focusing device.

The first laser beam of the first main pulse and the second laser beam of the second main pulse are deflected such that these are focused onto the target material with an angular offset of less than 1 μrad. Accordingly, it is ensured that both main pulses strike the target material. In this respect, it is advantageous for the respective mirrors which deflect the first main pulse and the second main pulse into the focusing device to have an optical distance of at least 50 m from the focusing lens of the focusing device. The mirror for deflecting the first main pulse after the delay is preferably designed as a part of the retardation apparatus.

An advantageous embodiment of the invention provides for the controller to be configured such that the first main pulse is initially introduced into the target chamber and then introduced into the retardation apparatus, for delaying purposes. Accordingly, the first main pulse is introduced into the target chamber in a first step without striking the target material.

The retardation apparatus comprises mirrors for beam deflection and provides a propagation path which is covered by the first main pulse before the latter is focused onto the target material with the second main pulse in temporally synchronized fashion.

An advantageous embodiment of the invention provides for the controller to be configured such that a ratio between a pulse frequency of the beam source and a target frequency of the target material generator is at least 2:1, in particular at least 4:1 and preferably at least 8:1. For example, the pulse frequency can be 160 kHz, i.e. the pulse-time difference is 6.25 μs, and the target frequency can be 80 kHz, i.e. a target time difference is 13 μs.

Further advantages, features and details emerge from the following description, in which various exemplary embodiments of the invention are illustrated with reference to the drawing.

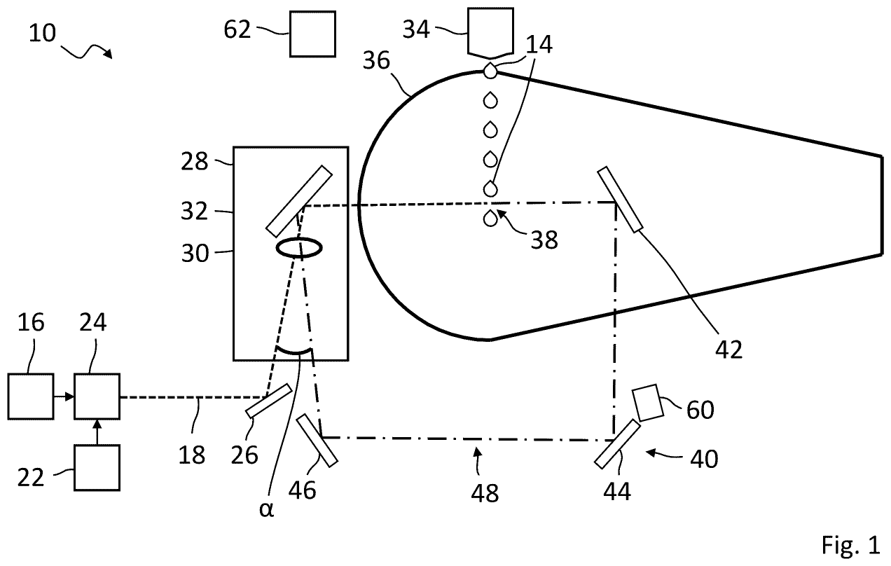

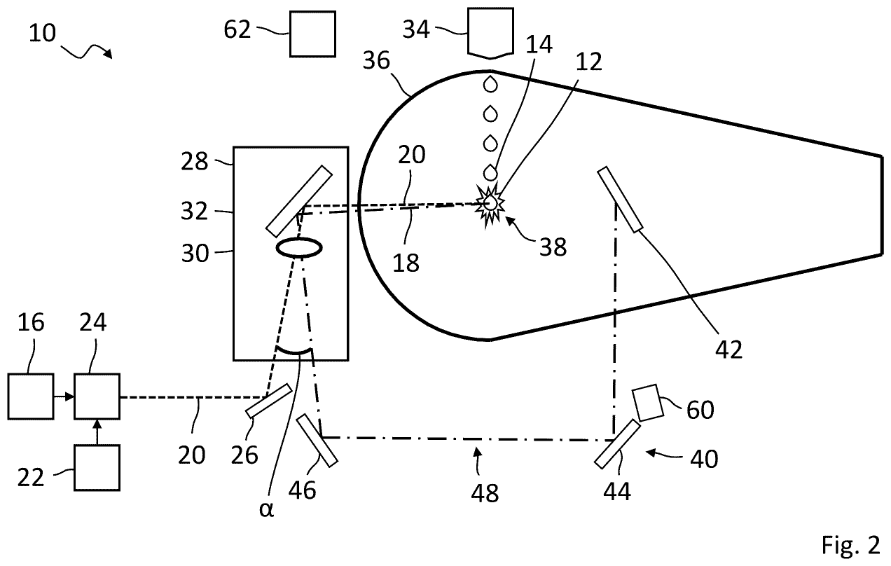

According to FIGS. 1 to 3, the laser apparatus 10 for generating an EUV light-emitting plasma 12 of a target material 14 comprises a pulsed beam source 16 for generating a first main pulse 18 and a second main pulse 20. The laser apparatus 10 furthermore comprises an amplifier arrangement 24 for amplifying the first main pulse 18 and the second main pulse 20 and comprises a pump source 22 for supplying at least one optical amplifier of the amplifier arrangement 24 with pump energy, wherein the optical amplifier has not been provided with a dedicated reference sign. The laser apparatus 10 comprises a first deflection mirror 26 for deflecting the generated first main pulse 18 and second main pulse 20 into a focusing device 28. The focusing device 28 comprises a focusing lens 30 and a second deflection mirror 32, which deflects and focuses the first main pulse 18 and the second main pulse 20 onto the target material 14.

By means of a target material generator 34, the target material 14 is provided in the form of droplets in a target chamber 36. To generate the plasma 12, the two main pulses 18, 20 are incident on the target material 14 at a point of incidence 38.

The first main pulse 18 and second main pulse 20 are generated at a pulse frequency, 160 kHz by way of example, and supplied to the target chamber 36. A retardation apparatus 40 is provided for synchronizing the two main pulses 18, 20, i.e. for ensuring that both main pulses 18, 20 are incident on the target material 14 simultaneously. According to FIG. 1, the first main pulse 18 is introduced into the target chamber 36 and passes the point of incidence 38 between two droplets of the target material 14. Accordingly, the first main pulse 18 is incident on a target mirror 42 which is disposed downstream of the point of incidence 38 in the beam direction and which introduces the droplet into the retardation apparatus 40. By preference, the point of incidence 38 is located between the target mirror 42 and the focusing device 28. By preference, the target mirror 42 is located in the target chamber 36. The retardation apparatus 40 preferably comprises at least one third deflection mirror 44 and at least one fourth deflection mirror 46. The deflection mirrors 44, 46 provide an optical path or a propagation path 48 which can be covered by the first main pulse 18. During this time, the beam source 16 is capable of charging sufficiently for the generation of a high-energy second main pulse 20.

Subsequently, according to FIG. 2, the first main pulse 18 is deflected by means of the fourth deflection mirror 46 and the second main pulse 20 is deflected by means of the third deflection mirror 44, in each case onto the focusing device 28, in particular the focusing lens 30. On account of the optical length traveled by the first main pulse 18 in the retardation apparatus 40, the first main pulse 18 and the second main pulse 20 are incident on the focusing lens 30 and the provided target material 14 substantially simultaneously.

The target material 14 is preferably provided at a target frequency in the range between 50 kHz and 110 kHz, 80 kHz by way of example. Given a pulse frequency of 160 kHz, this case requires the propagation path provided in the retardation apparatus 40 to have a length of 1874 m such that both main pulses 18, 20 are incident on the target material 14 simultaneously.

Furthermore, it is advantageous for the first main pulse 18 and the second main pulse 20 to be focused onto the target material 14 with an angular offset α of less than 1 μrad. Accordingly, it is ensured that both main pulses 18, 20 strike the target material 14, in particular the droplet. To this end, the third deflection mirror 44 and/or the fourth deflection mirror 46 have an optical distance of at least 50 m from the focusing lens 30 in the focusing device 28.

By virtue of the first main pulse 18 covering a propagation path 48 not covered by the second main pulse 20, temporal synchronization can be performed despite a pulse-time difference 54 between the generation of the first main pulse 18 and the second main pulse 20. Accordingly, the incidence-time difference 50 between the first main pulse 18 and the second main pulse 20 differs from the pulse-time difference 54.

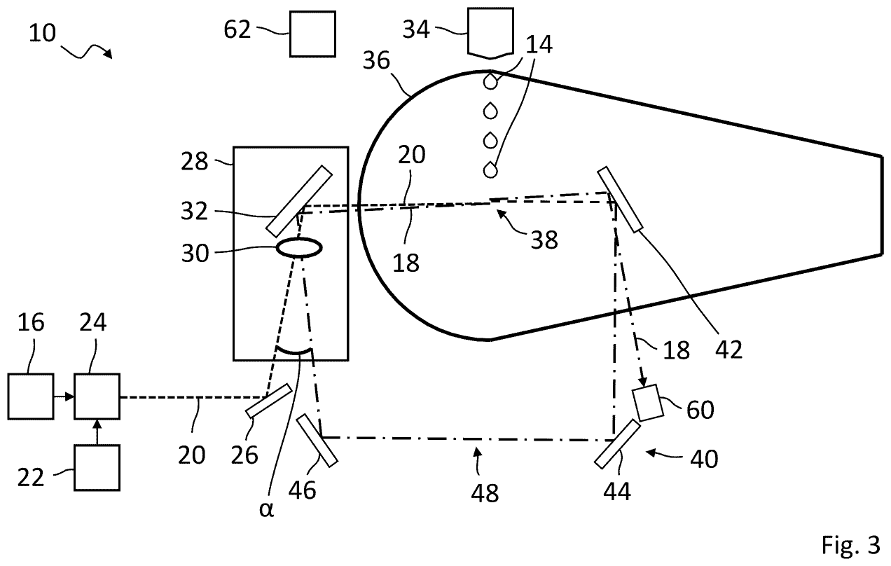

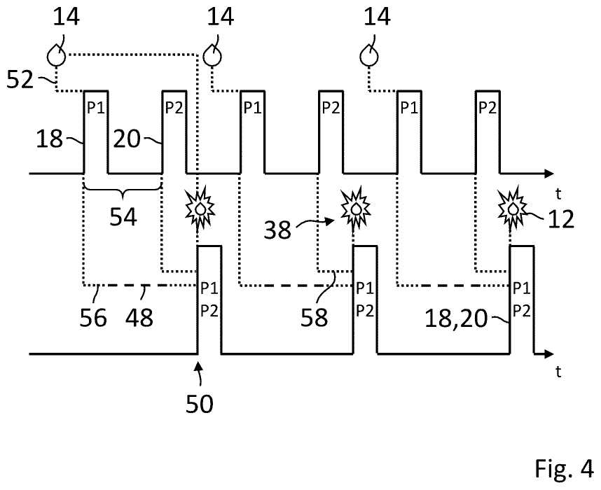

FIG. 4 shows this situation schematically, with the first time curve representing the main pulse generation and the second time curve representing the incidence on the target material 14. The target material generator 34 generates a droplet of target material 14. The droplet generation is accompanied by the generation of a target signal 52, which characterizes the time of droplet generation. The target signal 52 initiates the generation of the first main pulse 18 and, after a delay, the generation of the second main pulse 20 as well, with the delay corresponding to the pulse-time difference 54. The first main pulse 18 is subsequently delayed in the retardation apparatus 40, and so the two main pulses 18, 20 are synchronized in time. In FIG. 4, the delay of the first main pulse 18 is depicted using dashed and dotted lines. The dotted line represents the optical length 48 which both main pulses 18, 20 cover. The dashed line represents the optical path additionally covered by the first main pulse 18 owing to the retardation apparatus 40. Accordingly, the main pulses 18, 20 differ in the first time profile and coincide in the second time profile. In this case, an incidence-time difference 50 is 0. Accordingly, the main pulses 18, 20 are incident simultaneously on the droplet of target material 14 which, during the intervening time period in which the first main pulse 18 was generated and delayed in the retardation apparatus 40 and the second main pulse 20 was generated, has moved from the target material generator 34 to the point of incidence 38, preferably on account of gravity. The first main pulse 18 and the second main pulse 20 strike the target material 14 at the point of incidence 38 and generate the plasma 12.

Accordingly, the first main pulse 18 covers a first propagation path 56 and the second main pulse 20 covers a second propagation path 58. The first propagation path 56 is so much longer than the second propagation path 58 that the pulse-time difference 54 is compensated for. This leads to the incidence-time difference 50 being less than the pulse-time difference 54 and being 0 in particular. Alternatively, the incidence-time difference 50 may be designed to be less than 1 μs, in particular less than 0.5 μs and preferably less than 0.1 μs.

According to FIG. 3, the retardation apparatus 40 comprises a beam trap 60 for capturing the main pulse 18, 20 should a target signal 52 initiate the generation of a first main pulse 18 and/or of a second main pulse 20 without a target material 14 being provided at the point of incidence 38 at the expected time. The fourth deflection mirror 46 is preferably designed such that it deflects the first main pulse 18 to the focusing lens 30 with an angular offset <1 μrad. The angular offset is small enough that both main pulses 18, 20 are nevertheless incident on the droplet of target material 14. However, the angular offset of the first main pulse 18 with respect to the second main pulse 20 is sufficient so that the first main pulse 18 is deflected into the beam trap 60 by means of the target mirror 42 should no target material 14 be provided. This therefore prevents the main pulses 18, 20 from not being repeatedly deflected in the retardation apparatus 40. Although it is possible to provide a separate control of the target mirror 42 for deflecting the main pulses into the beam trap 60, it is possible to dispense therewith in this case.

The process of irradiating the target material 14 is repeated multiple times during the operation of the laser apparatus 10. Accordingly, a multiplicity of first and second main pulses 18, 20 and droplets of target material 14 are provided. It is likewise conceivable that four or eight main pulses are synchronized using the method described and the laser apparatus, and a droplet of target material is irradiated with said main pulses.

By preference, the laser apparatus 10 comprises a controller 62 for controlling the beam source 16 and the target material generator 34 and/or the retardation apparatus 40. By preference, the controller 62 is configured in such a way that the above-described method is carried out.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Laser apparatus
12 Plasma
14 Target material
16 Beam source
18 First main pulse
20 Second main pulse
22 Pump source
24 Amplifier arrangement
26 First deflection mirror
28 Focusing device
30 Focusing lens
32 Second deflection mirror
34 Target material generator
36 Target chamber
38 Location of incidence
40 Retardation apparatus
42 Target mirror
44 Third deflection mirror
46 Fourth deflection mirror
48 Propagation path
50 Incidence-time difference
52 Target signal
54 Pulse-time difference
56 First propagation path
58 Second propagation path
60 Beam trap
62 Controller

1. A method for generating an extreme ultraviolet (EUV) light-emitting plasma of a target material, the method comprising:
generating at least one first main pulse and at least one second main pulse with a pulse-time difference therebetween,
feeding the target material into a target chamber, and
causing the at least one first main pulse and the at least one second main pulse be incident on the target material with an incidence-time difference therebetween,
wherein the pulse-time difference is greater than the incidence-time difference.

2. The method as claimed in claim 1, wherein a ratio between the incidence-time difference and the pulse-time difference is less than 1:500.

3. The method as claimed in claim 1, wherein the incidence-time difference is less than 1 μs.

4. The method as claimed in claim 1, wherein a ratio between a pulse frequency of main pulse generation and a target frequency of target material generation is at least 2:1.

5. The method as claimed in claim 1, wherein the at least one first main pulse covers a first propagation path and the at least one second main pulse covers a second propagation path prior to incidence on the target material, wherein the at least one first main pulse is delayed in a retardation apparatus such that the first propagation path is longer than the second propagation path.

6. The method as claimed in claim 1, wherein the at least one first main pulse is introduced into the target chamber and subsequently delayed.

7. The method as claimed in claim 1, wherein the at least one first main pulse is guided into a beam trap when no target material is provided for the at least one first main pulse and/or the at least one second main pulse.

8. A laser apparatus for generating an extreme ultraviolet (EUV) light-emitting plasma of a target material, the laser apparatus comprising:
a pulsed beam source for generating at least one first main pulse and at least one second main pulse,
an amplifier arrangement having at least one optical amplifier for amplifying the at least one first main pulse and the at least one second main pulse,
a pump source for supplying the at least one optical amplifier with pump energy,
a focusing apparatus for focusing the at least one first main pulse and the at least one second main pulse onto the target material,
a target material generator for providing the target material in a target chamber,
a retardation apparatus for delaying the at least one first main pulse, and
a controller configured to control the pulsed beam source, the target material generator, and the retardation apparatus, such that the at least one first main pulse and the at least one second main pulse are generated by the pulsed beam source with a pulse-time difference, and the at least one first main pulse and the at least one second main pulse are incident on the target material with an incidence-time difference, wherein the pulse-time difference is greater than the incidence-time difference.

9. The laser apparatus as claimed in claim 8, wherein the controller is configured to control the pulsed beam source, the target material generator, and the retardation apparatus such that the incidence-time difference is less than 1 μs.

10. The laser apparatus as claimed in claim 8, wherein the retardation apparatus comprises a target mirror for introducing the at least one first main pulse into the retardation apparatus.

11. The laser apparatus as claimed in claim 8, wherein the retardation apparatus comprises a laser trap for absorbing the at least one first main pulse.

12. The laser apparatus as claimed in claim 8, wherein the target material generator is configured in a form of a droplet generator.

13. The laser apparatus as claimed in claim 8, wherein the controller is configured to initially introduce the at least one first main pulse into the target chamber and then introduce the at least one first main pulse into the retardation apparatus.

14. The laser apparatus as claimed in claim 8, wherein the controller is configured to control the pulsed beam source, the target material generator, and the retardation apparatus such that a ratio between a pulse frequency of the pulsed beam source and a target frequency of the target material generator is at least 2:1.
